(19) United States
(12) Patent Application Publication
(10) Pub. No.: US 2005/0013647 A1
(43) Pub. Date: Jan. 20, 2005

(54) Media marking for optical sensing of media advancement

(76) Inventors: David Claramunt, Barcelona (ES); Carles Flotats, Barcelona (ES); Cristian Cachera, Barcelona (ES); Jose M. Rio Doval, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/607,873

(22) Filed: Jun. 28, 2003

(51) Int. Cl. B41J 2/01

(52) U.S. Cl. 400/709

(57) ABSTRACT

A method of an embodiment of the invention is disclosed that advances media. As the media is advanced, the media is marked to allow for one-dimensional optical sensing of advancement of the media, while accommodating for lateral movement of the media.

### BACKGROUND

Image-forming devices are frequently used to form images on media, such as paper and other types of media. Image-forming devices include laser printers, inkjet printers, and other types of printers and other types of image-forming devices. Media is commonly moved through an image-forming device as the device forms the image on the media. The image-forming mechanism of the device, such as an inkjet-printing mechanism, may move in a direction perpendicular to that in which the media moves through the image-forming device. Alternatively, the image-forming mechanism may remain in place while the media moves past it.

For high-quality image formation, the movement of the media through an image-forming device is desirably precisely controlled. If the media moves more than intended, there may be gaps in the resulting image formed on the media, whereas if the media moves less than intended, there may be areas of overlap in the resulting image. An optical image-recognition media-advance sensor can be used to measure media advancement, which functions by capturing media images at two different times and comparing them to discern how much the media has advanced. Thus, the sensor should capture images of something on the media that the movement of which can be discerned.

### SUMMARY OF THE INVENTION

An embodiment of the invention advances media. As the media is advanced, the media is marked to allow for one-dimensional optical sensing of advancement of the media, while accommodating for lateral movement of the media.

### BRIEF DESCRIPTION OF THE DRAWINGS

The drawings referenced herein form a part of the specification. Features shown in the drawing are meant as illustrative of only some embodiments of the invention, and not of all embodiments of the invention, unless explicitly indicated, and implications to the contrary are otherwise not to be made.

FIG. 1 is a diagram of an example media-advancement sensing scenario, in conjunction with which embodiments of the invention may be implemented.

FIGS. 2A and 2B are diagrams of a bottom view and a side view, respectively, of media on which markings have been imprinted or otherwise applied, according to an embodiment of the invention.

FIG. 3 is a diagram of a side view of a valley of a marking that can be imprinted or otherwise applied to media, according to an embodiment of the invention.

FIGS. 4A and 4B are diagrams of an irregular pattern of marking and a regular pattern of marking, respectively, according to an embodiment of the invention.

FIGS. 5A and 5B are diagrams of successive example images captured by one or more optical image-recognition sensors and that can be utilized to discern media advancement, according to an embodiment of the invention.

FIGS. 6A and 6B are diagrams of scenarios showing how when there is no lateral media movement and when there is lateral media movement, respectively, media advancement can be discerned, according to varying embodiments of the invention.

FIGS. 7A and 7B are diagrams of media on which markings have been applied by roughening, according to varying embodiments of the invention.

FIG. 8 is a diagram of an example and representative roughening that can be a marking for determining media advancement, according to an embodiment of the invention.

FIG. 9 is a flowchart of a method of marking media for the optical sensing of media advancement, according to an embodiment of the invention.

FIGS. 10A and 10B are diagrams of a perspective view and a side view, respectively, of a marking wheel, according to an embodiment of the invention.

FIGS. 11A and 11B are diagrams of a side view and a front view, respectively, of the marking Wheel of FIGS. 10A and 10B, in which rotational, tangential, and latitudinal axes are identified, according to an embodiment of the invention.

FIG. 12 is an actual picture of the markings that can result from applying the marking wheel of FIGS. 10A and 10B to media, according to an embodiment Of the invention.

FIG. 13A is a flowchart of a method for constructing the marking wheel of FIGS. 10A and 10B, according to an embodiment of the invention.

FIGS. 13B and 13C are diagrams illustratively depicting performance of the method of FIG. 13A, according to an embodiment of the invention.

FIG. 14 is a diagram of a partial media-advance assembly including the marking wheel of FIGS. 10A and 10B, according to an embodiment of the invention.

FIGS. 15A and 15B are diagrams of a marking roller, according to varying embodiments of the invention.

FIG. 16 is a diagram of a partial media-advance assembly including the marking roller of FIG. 15B specifically, according to an embodiment of the invention.

FIG. 17 is a block diagram of an image-forming device, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

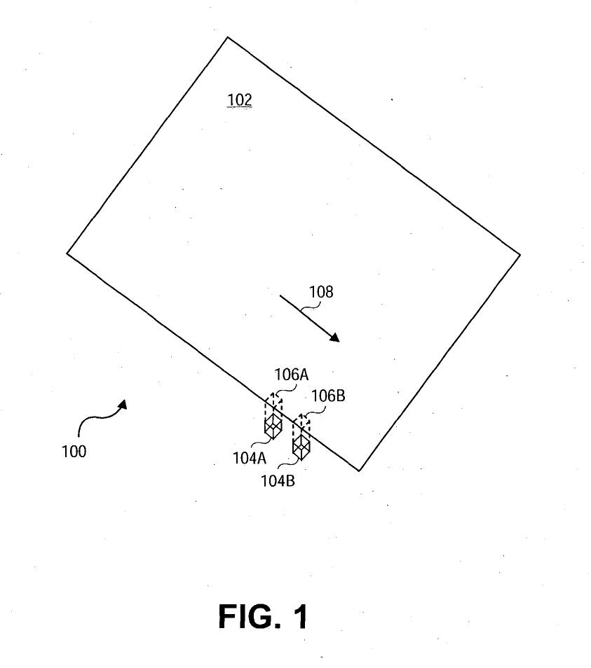

FIG. 1 shows an example media-advancement sensing scenario 100, in conjunction with which embodiments of the invention may be implemented. Media 102 is being advanced, or moved, as indicated by the arrow 108. The media 102 may be paper, or another type of media. As the media 102 is advanced, it passes over a pair of optical image-recognition sensors 104A and 104B. The sensors 104A and 104B capture images of respective portions 106A and 106B of the media 102 as the media 102 advances. By comparing the images of the portions 106A and 106B taken by the sensors 104A and 104B, the distance the media 102 has advanced in a given interval of time can be determined.

As can be appreciated by those of ordinary skill within the art, embodiments of the invention can be implemented in conjunction with other example media-advancement sensing scenarios, besides the scenario 100. For instance, there may be a single optical image-recognition sensor that captures images of the media 102 at different time intervals. The images captured over successive intervals may be compared to determine the distance the media 102 has advanced between these intervals of time.

To properly determine the distance the media 102 has advanced, optical image-recognition sensors, such as the sensors 104A and 104B of FIG. 1, desirably capture images of discernible subject matter on the media 102. To provide this discernible subject matter, one embodiment of the invention provides for the media 102 to be marked with markings as it is advanced. The optical image-recognition sensors capture images of these markings. The location of the markings in the images may then be compared to determine the distance the media 102 has advanced.

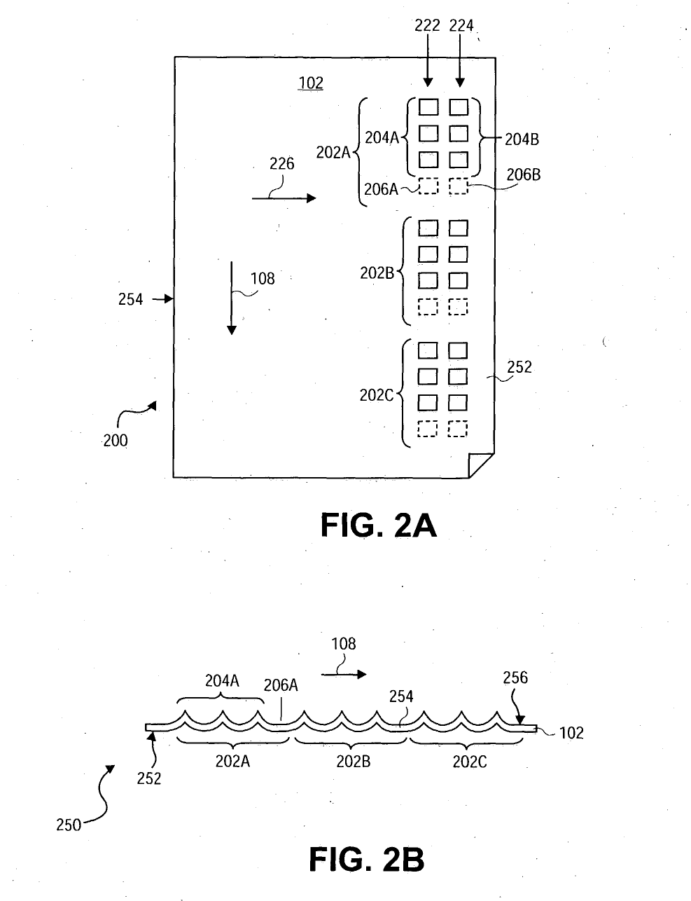

FIGS. 2A and 2B show a bottom view 200 and a side view 250 of the media 102 in which markings 202A, 202B, and 202C have been applied to the media 102, according to an embodiment of the invention. To determine the distance the media 102 has advanced in the direction indicated by the arrow 108, optical-image-recognition sensors, such as the sensors 104A and 104B of FIG. 1, capture images of at least some of the markings 202A, 202B, and 202C. The bottom view 200 of FIG. 2A depicts the bottom side 252 of the media 102, whereas the side view 250 of FIG. 2B depicts the left side 254 of the media 102.

As can be appreciated by those of ordinary skill within the art, the size of the markings 202A, 202B, and 202C in FIGS. 2A and 2B is greatly exaggerated for illustrative clarity. Thus, whereas only three sets of markings 202A, 202B, and 202C are depicted in FIGS. 2A and 2B, in actuality there may be tens or hundreds of such markings extending across the length of the media 102. Furthermore, whereas the markings 202A, 202B, and 202C are depicted in FIG. 2A as taking up a considerable portion of the width of the media 102, in actuality the markings 202A, 202B, and 202C may take up a tenth, a twentieth, or less, of the width of the media 102.

The markings 202A, 202B, and 202C are specifically depicted as having a pair of three valleys, followed by a pair of areas devoid of a valley. For instance, with respect to the marking 202A in particular, there are the three valleys 204A, followed by the area 206A devoid of a valley, and the three valleys 204B, followed by the area 206B devoid of a valley. In general, the first pairs of valleys and areas devoid of valleys of the markings 202A, 2028, and 202C lie within a column 222, whereas the second pairs of valleys and areas devoid of valleys of the markings 202A, 202B, and 202C lie within a column 224. The pairs of valleys and areas devoid of valleys are along a lateral direction, indicated by the arrow 226, which is perpendicular to the direction of media advanced indicated by the arrow 108.

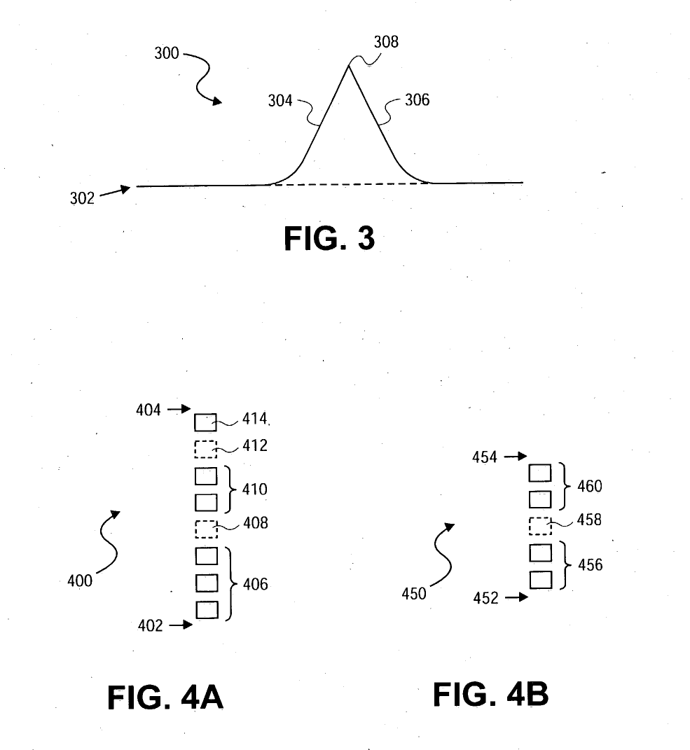

The term valley is descriptive of the markings from the perspective of the bottom side 252 of the media 102. From the opposite, or top side 256, of the media 102, the valleys are actually peaks. A valley is generally defined as having sides that depart from the plane of the media 102 in desirably a tapering fashion, until they meet, desirably at a sharp or rounded point. FIG. 3 illustratively depicts a side view of a valley 300 consistent with this definition, according to an embodiment of the invention. The sides 304 and 306 of the valley 300 depart from the media plane 302, and meet at a point 308.

Referring back to FIGS. 2A and 2B, the markings 202A, 202B, and 202C have irregular patterns. For instance, with respect to the marking 202A, the areas 206A and 206B devoid of valleys lead, and are followed by the valleys 204A and 204B, respectively. That is, the markings 202A, 202B, and 202C have patterns that are irregular in that the leading ends of the markings are discernible from the lagging ends of the markings by inspecting the valleys, or areas devoid of valleys, of the markings.

For comparison, FIGS. 4A and 4B show bottom views of an irregular pattern 400 and a regular pattern 450, according to varying embodiments of the invention. In FIG. 4A, the pattern 400 has, from the leading end 402 to the lagging end 404, three valleys 406, an area 408 devoid of a valley, two valleys 410, an area devoid of a valley 412, and a valley 414. The pattern 400 is irregular, because the leading end 402 is discernible from the lagging end 404. The leading end 402 has the three valleys 406 followed by the area 408 devoid of a valley and is thus discernible from the lagging end 404, which has the valley 414, the area 412 devoid of a valley, and the two valleys 410.

In FIG. 4B, the pattern 450 has, from the leading end 452 to the lagging end 454, two valleys 456, an area 458 devoid of a valley, and two valleys 460. The pattern 450 is regular, because the leading end 452 is not discernible from the lagging end 454. Each of the leading end 452 and the lagging end 454 has two valleys followed by an area devoid of a valley. The leading end 452 has the valleys 456 followed by the area 458 devoid off a valley, whereas the lagging end 454 has the valleys 460 followed by the area 458 devoid of a valley.

The irregular patterns of the markings 202A, 202B, and 202C allow the optical image-recognition sensors to determine the positioning of the media 102 so long as the sensors each have a field of view of at least the length of the markings and the sensors capture successive images of at least portions of one of the markings. The markings 202A, 202B, and 202C thus are sized, or have a size, to match the field of view of the one-dimensional optical sensor being employed. The field of view of the optical sensor is the size of the images 500 and 550 that can be captured by the sensor. For example, in one particular embodiment, each individual marking of the markings 202A, 202B, and 202C, such as each peak or each valley, is thirty-to-forty micron in width and in length.

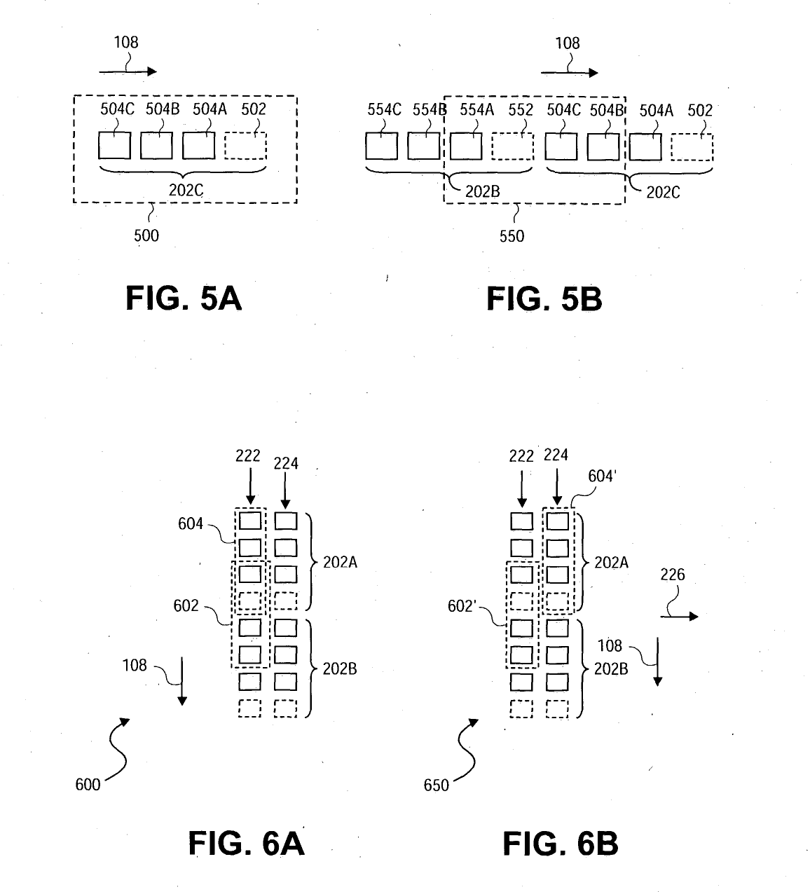

As an illustrative example, FIGS. 5A and 5B depict two successive images 500 and 550, respectively, captured by the same or different optical image-recognition sensors at different times, according to an embodiment of the invention. In FIG. 5A, the image 500 has captured the marking 202C, having the area 502 devoid of a valley followed by the three valleys 504A, 504B, and 504C. It is noted that the valleys 504A, 504B, and 504C, and the area 502, are part of the column 222 or the column 224 of FIG. 2. The valleys and the area of the marking 202C in the other of the columns 222 and 224 are not depicted in FIG. 5A.

In FIG. 5B, the image 550 has captured the valleys 504B and 504C of the marking 202C, and the area 552 and the valley 554A of the marking 202B. For sake of completeness, the area 502 devoid of a valley and the valley 504A of the marking 202B, as well as the valleys 554B and 554C of the marking 202C, are shown in FIG. 5B, even though they are not a part of the image 550. As in FIG. 5A, the valleys 504A, 504B, and 504C, and the area 502, of the marking 202C, and the valleys 554A, 554B, and 554C, and the area 552, of the marking 202B, are part of the column 222 or the column 224 of FIG. 2. The valleys and the areas of the markings 202B and 202C in the other of the columns 222 and 224 are not depicted in FIG. 5B.

It is assumed that the successive images 500 and 550 of FIGS. 5A and 5B capture at least portions of one of the markings. Since the image 500 is completely of the marking 202C, it is known that the image 550 is of at least a portion of the marking 202C. Furthermore, because the direction of media advancement is from left to right, as indicated by the arrow 108 in FIGS. 5A and 5B, it is known that the right part of the image 550 in FIG. 5B will be of the marking 202C. Thus, it can be discerned that the valleys 504B and 504C in the image 550 are the valleys 504B and 504C of the marking 202C, because the area 552 that immediately follows is devoid of a valley, and therefore could only be a part of the marking 202B. The distance of media advancement between the images 500 and 550 can be determined as the length of an area devoid of a valley plus the length of a valley. This is because the area 502 and the valley 504A are part of the image 500 but not part of the image 550, and conversely because the area 552 and the valley 554A are part of the image 550 but not part of the image 500.

Duplicating the irregular pattern of the markings 202A, 202B, and 202C so that the markings include at least a pair of copies of the pattern in a lateral direction perpendicular to the direction of media advancement accommodates proper discernment of media advance when the media has undesirably moved. That is, the irregular pattern of the markings 202A, 202B, and 202C is repeated over a number of tracks in the lateral direction perpendicular to the direction of media. For instance, referring back to FIG. 2A, the media 102 desirably moves only in the direction of media advancement indicated by the arrow 108. However, if not properly aligned, or for other reasons, it may undesirably move in the lateral direction indicated by the arrow 226. Because the markings 202A, 202B, and 202C have patterns duplicated over the columns 222 and 224, discerning media advancement by utilization of one or more optical image-recognition sensors can still be accomplished.

FIGS. 6A and 6B illustratively depict scenarios 600 and 650 that show how media advancement may still be discerned even when the media has laterally moved, according to varying embodiments of the invention. In FIG. 6A, there is no lateral media movement, and the direction of media advance is completely characterized by the arrow 108. Thus, a first captured image 602 and a second captured image 604 may include portions of the markings 202B and 202A within the column 222, as shown in FIG. 6A, but not within the column 224. The common portion of the marking 202B in the captured images 602 and 604 allows for media advancement to be determined.

By comparison, in FIG. 6B, there is lateral media movement. The media advances desirably in the direction indicated by the arrow 108, and partially and undesirably in the direction indicated by the arrow 226. Whereas the first captured image 602′ may include portions of the markings 202B and 202A within the column 222, as shown in FIG. 6B, the second capture image 604′ may include portions of the markings 202B and 202A within the column 224. That is, from a literal standpoint there is no common subject matter between the images 602′ and 604′. However, because the patterns of the markings 202B and 202A are duplicated over the columns 222 and 224, media advancement may still be determined. For the sake of determining media advancement it can be assumed that second image 604′ has captured patterns of the column 222, even though in actuality it has captured patterns of the column 224.

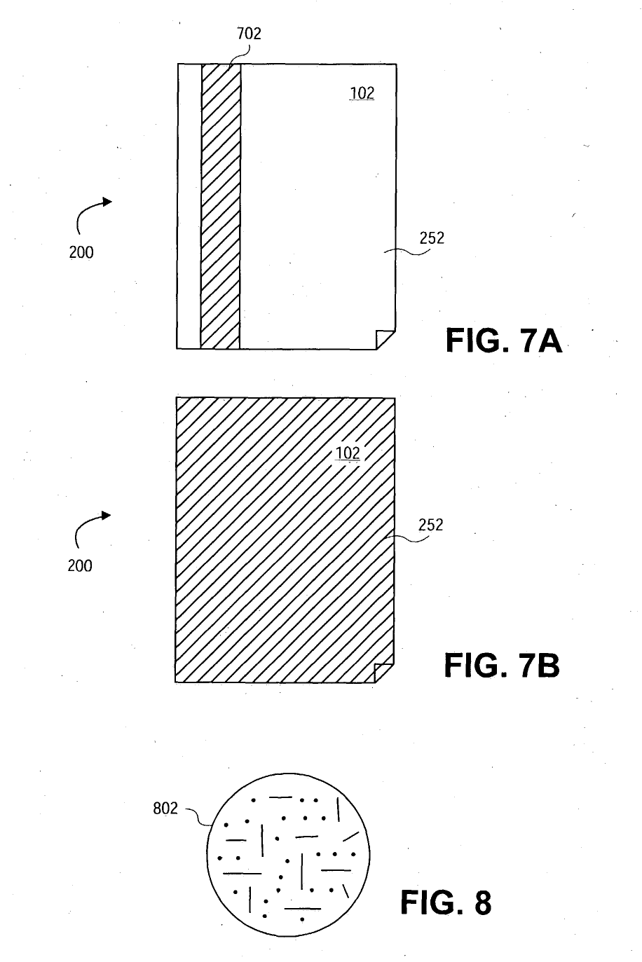

Thus far, embodiments of the invention have been described in which markings are imprinted onto the media 102 to enable optical image-recognition sensors to capture images of subject matter that allow for media advancement to be discerned. In another embodiment of the invention, the media 102 is roughened to provide such markings, and thus the subject matter of which images can be captured by optical image-recognition sensors to discern media advancement. FIGS. 7A and 7B show the bottom view 200 of the media 102, where the media 102 has been roughened, according to varying embodiments of the invention. Roughening of the media 102 is generally defined as randomly marking the media 102, such as with a grit wheel, where slippage does not occur between the grit wheel and the media 102.

In FIG. 7A, a band 702 running length-wise down the media 102 represents the portion of the bottom side 252 of the media 102 that has been roughened, as indicated by the shading of the band 702. By comparison, in FIG. 7B, the entire bottom side 252 of the media 102 has been roughened, as indicated by the shading of the entire bottom side 252 of the media 102. Roughening the media creates the subject matter of which images can be captured by optical image-recognition sensors to discern media advancement. In practical effect, the roughening creates unique subject matter that can be discerned over successive images captured by one or more optical sensors.

FIG. 8 shows an enlarged example representative roughening 802, according to an embodiment of the invention. The roughening 802 is a different type of marking that can be imprinted on the media 102. The various points and lines within the roughening 802 represent fibers, pits, valleys, scratches, and so on, of the media 102 that are captured in images by one or more optical image-recognition sensors. By discerning how these various points and lines, and their alignment with respect to one another, move over successive images captured by optical sensors, the distance the media 102 has advanced over the successive images can be determined, similar to how the media advancement is discerned as has been described with the markings 202A, 202B, and 202C.

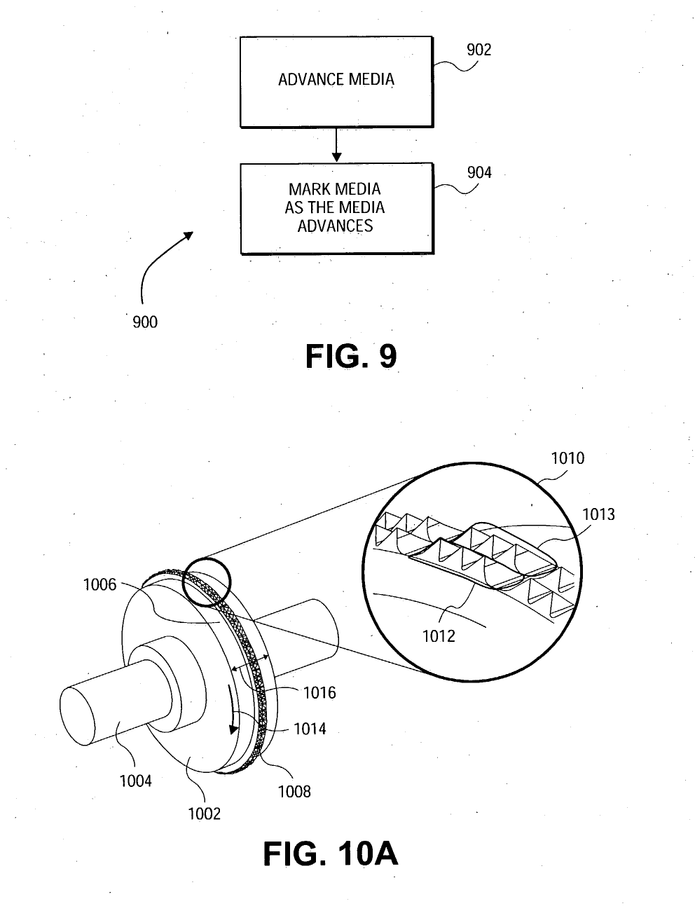

FIG. 9 shows a method 900 that summarizes media marking for the optical sensing of media advancement as has been described, according to an embodiment of the invention. The media is advanced (902), and while the media is advanced, it is marked (904) to allow for one-dimensional optical sensing of media advancement while accommodating lateral movement of the media. The optical sensing is one-dimensional in that the images captured are preferably one pixel in width. That is, the images are one-dimensional linear arrays of pixels, as opposed to two-dimensional rectangular arrays of pixels. The marking provides the discernment of media advancement using such linear arrays of pixels even when in the presence of lateral media movement.

For instance, as has been described in relation to FIGS. 6A and 6B, the images 602, 604, 602′ and 604′ are one-dimensional linear arrays of pixels. With particular respect to FIG. 6B, the markings 202A and 202B having irregular patterns within the columns 222 and 224 allow for the images 602′ and 604′ to provide the basis upon which media advancement is discerned. Even where the media moves over the direction indicated by the arrow 226, the presence of the irregular patterns of the markings 202A and 202B in both the columns 222 and 224 allow for media advancement to still be discerned. As can be appreciated by those of ordinary skill within the art, the roughening of media as has been described in relation to FIGS. 7A, 7B, and 8 also provides for the discernment of media advancement even in the presence of lateral media movement.

The marking of the media as the media advances in 904 of the method 900 of FIG. 9 can be accomplished by marking an irregular pattern on the media a number of times in one direction while the media advances in another, perpendicular direction. For instance, in FIG. 2A, the media 102 advances in the direction indicated by the arrow 108, and is marked twice in the perpendicular direction indicated by the arrow 226, as evidenced by the columns 222 and 224 of irregular patterns of the markings 202A, 202B, and 202C. Such an irregular pattern can include a number of valleys followed by a space devoid of a valley, as has been described.

Alternatively, the marking of the media as the media advances in 904 of the method 900 of FIG. 9 can be accomplished by two-dimensionally roughening the media as it advances. For instance, in FIG. 7A, the of the media 102 is accomplished over the band 702 of the media 102, where the band 702 has a width that is greater than the one-pixel width of the optical image-recognition sensors employed to capture corresponding one pixel-wide images. Thus, the band 702 that is roughened has two dimensions, a dimension along the width of the media 102, and a dimension along the length of the media 102. Similarly, in FIG. 7B, the roughening of the entire bottom side 252 of the media 252 is two dimensional in nature, being across the entire width of the media 102 and across the entire length of the media 102.

Marking Wheel with Marking Geometry

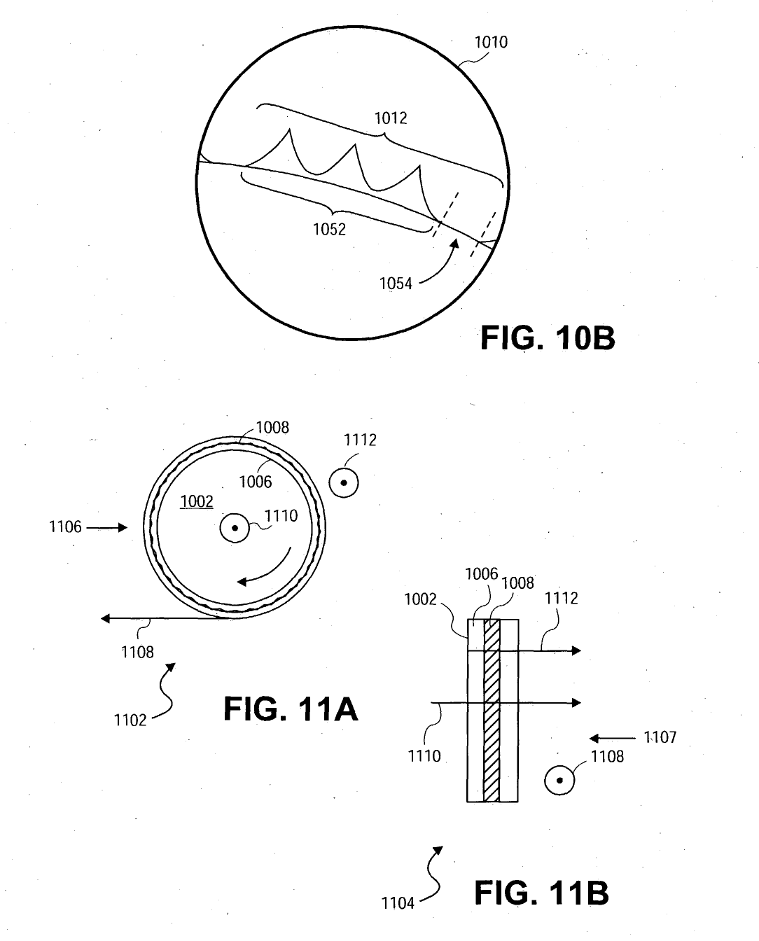

FIG. 10A shows a diagram of a perspective view of a marking wheel 1000 and FIG. 10B shows a diagram of a side view of an enlarged portion 1010 of the marking wheel 1000, according to an embodiment of the invention. The marking wheel 1000 enables markings, such as the markings 202A, 202B, and 202C of FIGS. 2A and 2B, to be imprinted or otherwise applied to media. The marking wheel 1000 includes a cylinder 1002 concentrically mounted on a rotatable shaft 1004. As a result, when the rotatable shaft 1004 rotates, the cylinder 1002 correspondingly rotates, as indicated by the arrow 1014. The cylinder 1002 includes an outer surface 1006 that contacts media as the cylinder 1002 rotates and as media moves over the cylinder 1002.

The outer surface 1006 of the cylinder 1002 of the marking wheel 1000 has a marking geometry 1008. The marking geometry 1008 is that which actually causes markings to be applied to media, such as the markings 202A, 202B, and 202C of FIGS. 2A and 2B. An enlarged portion 1010 of the marking wheel 1000, and specifically of the marking geometry 1008, is specifically shown in FIGS. 10A and 10B. The irregular patterns 1012 and 1013 of the marking geometry 1008 are repeated over the outer surface 1006 of the cylinder 1002 along the rotational direction indicated by the arrow 1014, preferably completely around the outer surface 1006.

The irregular pattern 1013 is a repeat of the irregular pattern 1012 along a lateral direction over the outer surface 1006, indicated by the arrow 1016, that is perpendicular to the direction indicated by the arrow 1014. As can be appreciated by those of ordinary skill within the art, whereas the irregular pattern 1012 is repeated as only the irregular pattern 1013 in the direction indicated by the arrow 1016 in FIGS. 10A and 10B, in other embodiments there may be more than two instances, or repetitions, of an irregular pattern along the lateral direction indicated by the arrow 1016 over the surface 1006. That is, whereas the irregular patterns 1012 and 1013 represent an irregular pattern being repeated two patterns deep in the direction indicated by the arrow 1016, in other embodiments an irregular pattern may be repeated more than two patterns deep in the direction indicated by the arrow 1016.

In FIG. 10B specifically, the irregular pattern 1012 is depicted as including three peaks 1052, and an area 1054 devoid of a peak. More generally, an irregular pattern may include a number of peaks other than three, and may include more than one area devoid of a peak, so long as the pattern is irregular, the definition of which has been described in the previous section of the detailed description. The three peaks 1052 and the area 1054 devoid of a peak, when repeatedly applied to media, can cause the markings 202A, 202B, and 202C of FIGS. 2A and 2B. For instance, the three peaks 1052 can cause and correspond to the valleys 204A of the marking 202A, and the area 1054 devoid of a peak can correspond to the area 206A devoid of a valley. That is, when the wheel 1000 is applied to the bottom side 252 of the media 102, the three peaks 1052 of the irregular pattern 1012 can create the valleys 204 of the marking 202A as viewed from the perspective of the bottom side 252, as is specifically depicted in FIG. 2B. The area 1054 devoid of a peak of the irregular pattern 1012 can result in the area 206A devoid of a valley of the marking 202A.

FIGS. 11A and 11B show a side view 1102 and a front view 1104, respectively, of the cylinder 1002 of the marking wheel 1000, according to an embodiment of the invention. The side view 1102 of FIG. 11A is from the perspective of the arrow 1107 of FIG. 11B, and the front view 1104 of FIG. 11B is from the perspective of the arrow 1106 of FIG. 11A. FIGS. 11A and 11B are particularly presented so as to provide another manner by which the marking geometry 1008 on the outer surface 1006 of the marking wheel 1000 can be described.

The cylinder 1002 rotates around an axis of rotation 1110 in the direction indicated by the arrow 1014. The axis of rotation 1110 is depicted in FIG. 11A as a point within a circle, which is used to denote that the axis of rotation is perpendicular to and comes out of the plane of FIG. 11A. The cylinder 1002 also has a tangential axis 1108, which is where the cylinder 1002 can come into contact with media. That is, media can move relative to the cylinder 1002 as the cylinder 1002 rotates, in a direction parallel to the tangential axis 1108. The tangential axis 1108 is depicted in FIG. 11B as a point within a circle, which similarly denotes that the tangential axis 1108 is perpendicular to and comes out of the plane of FIG. 11B. Finally, the cylinder 1002 has a latitudinal axis 1112, which is latitudinally across the outer surface 1006 of the cylinder 1002, and which is perpendicular to the tangential axis 1108. The latitudinal axis 1112 is depicted in FIG. 11A as a point within a circle, denoting that the latitudinal axis 1112 is perpendicular to and comes out of the plane of FIG. 11A.

The marking geometry 1008 can thus be described as having an irregular pattern, such as the irregular pattern 1052 of FIGS. 10A and 10B, repeated over the outer surface 1006 of the cylinder 1002 angularly relative to the axis of rotation 1110, and parallel to the latitudinal axis 1112 that is perpendicular to the tangential axis 1108. That is, the irregular pattern is repeated completely around the outer surface 1006, and this repetition can correspond to the statement that the pattern repeats angularly relative to the axis of rotation 1110. Furthermore, the irregular pattern is repeated along the direction indicated by the arrow 1016 of FIG. 1A, resulting in, for instance, the two pattern-deep irregular patterns 1012 and 1013 of FIG. 1A, and this repetition corresponds-to the statement that the pattern repeats parallel to the latitudinal axis 1112.

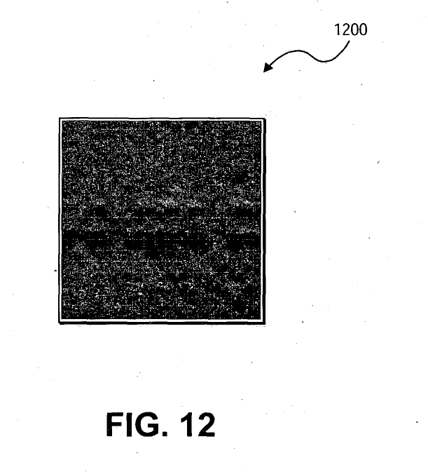

FIG. 12 shows an actual picture 1200 of the marking that can result from applying the marking wheel 1000 to media, according to an embodiment of the invention. The picture 1200 is taken from a perspective of a top side of the media, and thus depicts peaks rather than valleys. This is the converse of the valleys 204A of the marking 202A of FIG. 2B when viewed from the perspective of the bottom side 252 of the media 102, for instance, as can be appreciated by those of ordinary skill within the art.

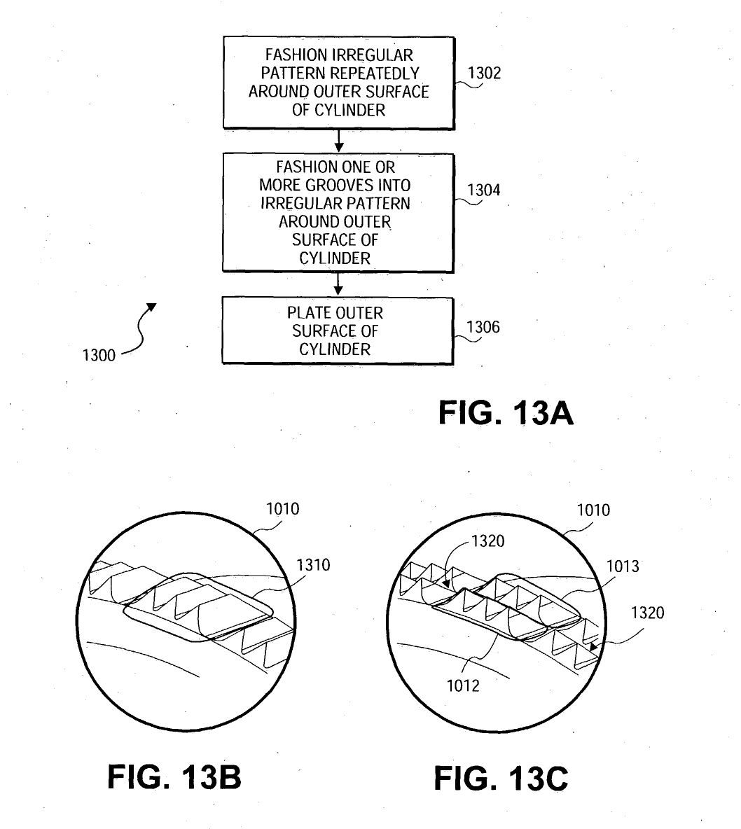

FIG. 13A shows a method 1300 for manufacturing a marking wheel, such as the marking wheel 1000, according to an embodiment of the invention. First, an irregular pattern is fashioned repeatedly around the outer surface of a cylinder of the marking wheel (1302). That is, the irregular pattern may be broached repeatedly around the outer surface of the cylinder. With respect to the marking wheel 1000, performing 1302 is illustratively depicted in FIG. 13B, which shows the enlarged portion 1010 of the cylinder 1002 of the marking wheel 1000 after performance of 1302, according to an embodiment of the invention. There is an irregular pattern 1310, from Which the irregular patterns 1012 and 1013 will be subsequently constructed.

Referring back to FIG. 13A, one or more grooves are next fashioned into the irregular pattern around the outer surface of the cylinder of the marking wheel (1304). That is, the grooves may be turned or scored into the irregular pattern, in a direction perpendicular to the irregular pattern, to duplicate the irregular pattern. With respect to the marking wheel 1000, performing 1304 is illustratively depicted in FIG. 13C, which shows the enlarged portion of the cylinder 1002 of the marking wheel 1000 after performance of 1304, according to an embodiment of the invention. The irregular pattern 1310 of FIG. 13B has had a groove 1320 turned into it, resulting in the irregular patterns 1012 and 1013 of FIG. 10A. Referring back to FIG. 13A, the method 1300 can conclude by plating the outer surface of the cylinder (1306), to achieve a desired hardness or other properties.

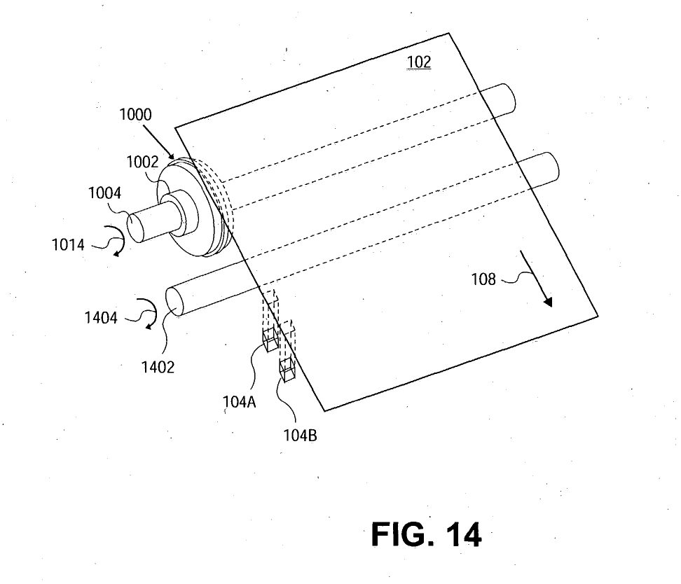

FIG. 14 shows a partial media-advance assembly 1400 that includes the marking wheel 1000, according to an embodiment of the invention. The media-advance assembly 1400 may be utilized in conjunction with an image-forming device, such as an inkjet printer or another type of image-forming device. The assembly 1400 includes a roller shaft 1402 that rotates in the direction indicated by the arrow 1404, so that the media 102 advances in the direction indicated by the arrow 108. Concurrently, the marking wheel 1000, which is more generally a marking mechanism, rotates in the direction indicated by the arrow 1014 due to corresponding rotation of the shaft 1004 on which it is situated, to mark the underside of the media 102 as it advances. Thus, the optical image-recognition sensors 104A and 104B can sense and determine the advancement of the media utilizing the markings applied to the media 102 by the marking Wheel 1000.

Marking Roller With Grit

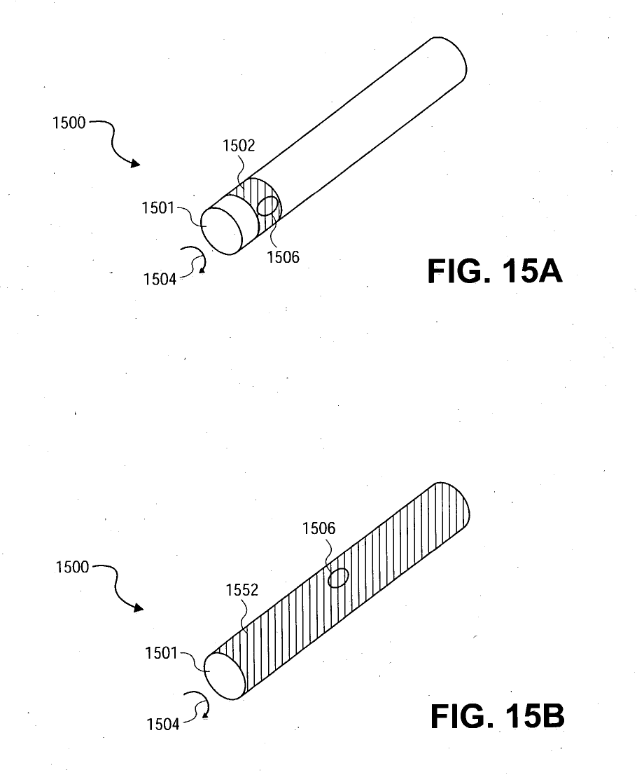

FIGS. 15A and 15B show a marking roller 1500, according to varying embodiments of the invention. The marking roller 1500 enables markings, such as the roughening 802 of FIG. 8, to be imprinted or otherwise applied to media. The marking roller 1500 includes a cylinder 1501 that rotates in the direction indicated by the arrow 1504. In the embodiment of FIG. 15A, an outer surface band 1502 of the cylinder 1501 has coarse grit 1506 applied thereto to roughen media, whereas in the embodiment of FIG. 15B, the complete outer surface 1552 of the cylinder 1501 has the coarse grit 1506 applied thereto to roughen media. The coarse grit 1506 is specifically indicated in FIGS. 15A and 15B by shading. Thus, the marking roller 1500 of FIG. 15A can roughen media to result in a roughened band on a side of the media, an example of which has been described in relation to FIG. 7A. By comparison, the marking roller of FIG. 15B can roughen media to result in an entire side of the media being roughened, an example of which has been described in relation to FIG. 7B.

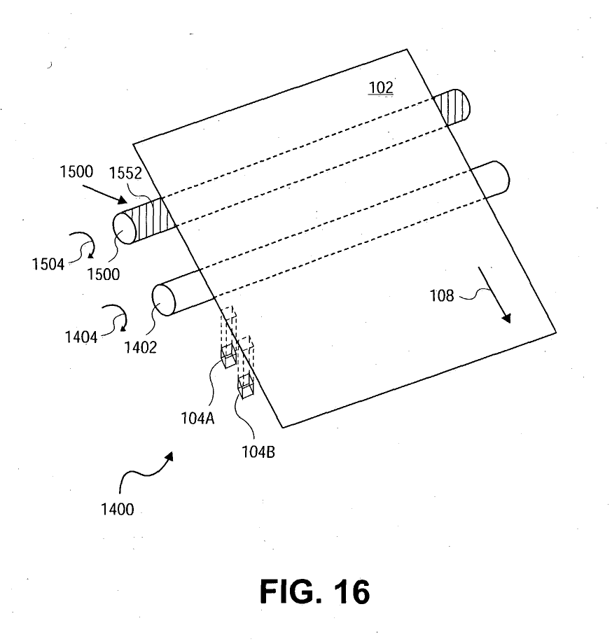

FIG. 16 shows the partial media-advance assembly 1400 as including the marking roller 1500, according to an embodiment of the invention. The media-advance assembly 1400 may be utilized in conjunction with an image-forming device, such as an inkjet printer. The assembly 1400, as before, includes the roller shaft 1402 that rotates in the direction indicated by the arrow 1404, so that the media 102 advances in the direction indicated by the arrow 108. Concurrently, the marking roller 1500, which is more generally a marking mechanism, rotates in the direction indicated by the arrow 1504, to mark, or roughen, the underside of the media 102 as it advances. The marking roller 1500 is specifically depicted in FIG. 16 as the embodiment of the marking roller 1500 of FIG. 15B, in which the entire outer surface 1552 of the cylinder 1501 of the marking roller 1500 has coarse grit applied thereto. The optical image-recognition sensors 104A and 104B can then sense and determine the advancement of the media utilizing the markings applied to the media 102 by the marking roller 1500.

Image-Forming Device and Conclusion

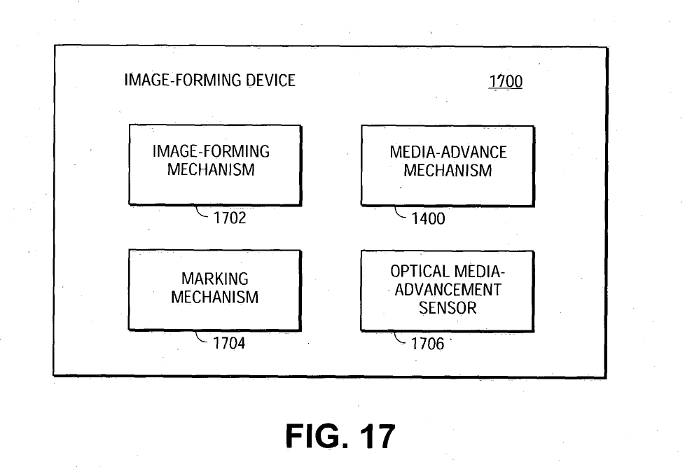

FIG. 17 shows a block diagram of an image-forming device 1700, according to an embodiment of the invention. As can be appreciated by those of ordinary skill within the art, the image-forming device 1700 may include components in addition to or in lieu of those depicted in FIG. 17. The image-forming device 1700 may be a laser printer, an inkjet printer, or another type of image-forming device. The image-forming device 1700 includes an image-forming mechanism 1702, a media-advance mechanism 1400, a marking mechanism 1704, and an optical media-advancement sensor 1706.

The image-forming mechanism 1702 is the mechanism that actually forms an image onto media. The mechanism 1702 may be an inkjet-printing mechanism, a laser-printing mechanism, or another type of image-forming mechanism. The media-advance mechanism 1400, which has been described in relation to and partially depicted in FIGS. 14 and 16, advances media through the image-forming device 1700 so that the image-forming mechanism 1702 can form an image onto the media. In one embodiment, the marking mechanism 1704 and/or the optical media-advancement sensor 1706 are part of the media-advance mechanism 1400.

The marking mechanism 1704 marks media as the media is advanced through the image-forming mechanism 1702, the resulting markings which allow for measurement of advancement of the media by the optical media-advancement sensor 1706 even in presence of lateral movement of the media. Thus, the sensor 1706, which can in one embodiment include the sensors 104A and 104B of FIG. 1, measures advancement of the media based on the markings on the media made by the marking mechanism 1704. The marking mechanism 1704 can in one embodiment be or include the marking wheel 1000 of FIG. 10 or the marking roller 1500 of FIG. 15.

It is noted that, although specific embodiments have been illustrated and described herein, it will be appreciated by those of ordinary skill in the art that any arrangement that is calculated to achieve the same purpose may be substituted for the specific embodiments shown. Other applications and uses of embodiments of the invention, besides those described herein, are amenable to at least some embodiments. This application is intended to cover any adaptations or variations of the present invention. Therefore, it is manifestly intended that this invention be limited only by the claims and equivalents thereof.

1. A method comprising:
advancing media; and,
marking the media as the media advances to allow for one-dimensional optical sensing of advancement of the media while accommodating for lateral movement of the media.

2. The method of claim 1, wherein marking the media as the media advances comprises marking the media with a mark size matching a field of view of an optical sensor used in the one-dimensional optical sensing of the advancement of the media that allows for the one-dimensional optical sensing of the advancement of the media while accommodating for the lateral movement of the media.

3. The method of claim 1, wherein marking the media as the media advances comprises, as the media advances in a first direction, marking an irregular pattern on the media over a plurality of tracks in a second direction perpendicular to the first direction.

4. The method of claim 3, wherein marking the irregular pattern on the media the plurality of times in the second direction comprises marking the irregular pattern on the media over two tracks in the second direction.

5. The method of claim 3, wherein marking the irregular pattern on the media comprises marking a plurality of valleys followed by a space devoid of a valley on the media as the media advances.

6. The method of claim 1, wherein marking the media as the media advances comprises two-dimensionally roughening the media as the media advances.

7. The method of claim 6, wherein two-dimensionally roughening the media as the media advances comprises roughening the media across a width of the media.

8. The method of claim 6, wherein two-dimensionally roughening the media as the media advances comprises roughening the media across less than a width of the media.

9. A marking wheel for an optical media advancement sensor comprising:
a cylinder having an outer surface to contact media as the cylinder rotates and as the media moves relative to the cylinder; and,
a marking geometry on the outer surface of the cylinder having an irregular pattern repeated over the outer surface in a first direction around the cylinder over a plurality of tracks in a second direction perpendicular to the first direction.

10. The marking wheel of claim 9, wherein the irregular pattern has a size matching a field of view of the optical media advancement sensor.

11. The marking wheel of claim 9, wherein the irregular pattern is repeated over the outer surface completely around the outer surface in the first direction.

12. The marking wheel of claim 9, wherein the irregular pattern is repeated over the outer surface over two tracks in the second direction.

13. The marking wheel of claim 9, wherein the irregular pattern comprises a plurality of peaks and an area devoid of a peak.

14. The marking wheel of claim 13, wherein the irregular pattern comprises three peaks and the area devoid of a peak.

15. A marking wheel for an optical media advancement sensor comprising:
a cylinder having an outer surface to contact media as the cylinder rotates and as the media moves relative to the cylinder; and,
means for marking the media disposed on the outer surface of the cylinder and to allow for one-dimensional optical sensing of advancement of the media while accommodating for lateral movement of the media.

16. The marking wheel of claim 15, wherein the means comprises a marking geometry on the outer surface of the cylinder having an irregular pattern repeated over the outer surface in a first direction around the cylinder and over a plurality of tracks in a second direction perpendicular to the first direction.

17. A method for manufacturing a marking wheel for an optical media advancement sensor comprising:
fashioning an irregular pattern repeatedly around an outer surface of a cylinder; and,
fashioning one or more grooves into the irregular pattern around the outer surface of the cylinder in a direction around the cylinder.

18. The method of claim 17, further comprising plating the outer surface of the cylinder.

19. The method of claim 17, wherein fashioning the irregular pattern repeatedly around the outer surface of the cylinder comprises broaching the irregular pattern repeatedly around the outer surface of the cylinder.

20. The method of claim 17, wherein fashioning the one or more grooves into the irregular pattern around the outer surface of the cylinder in the direction around the cylinder comprises turning the one or more grooves into the irregular pattern around the outer surface of the cylinder in the direction around the cylinder.

21. An image-forming device comprising:
an image-forming mechanism;
a media-advance mechanism to advance media through the image-forming mechanism;
a marking mechanism to mark the media as the media is advanced through the image-forming mechanism; and,
a one-dimensional optical media-advancement sensor to measure advancement of the media based on markings on the media made by the marking mechanism,
the markings allowing for measurement of advancement of the media by the sensor in presence of lateral movement of the media.

22. The image-forming device of claim 21, wherein the marking mechanism comprises a cylinder having an outer surface to contact the media as the cylinder rotates and as the media advances, the outer surface having a marking geometry with an irregular pattern repeated over the outer surface in a first direction around the cylinder and over a plurality of tracks in a second direction perpendicular to the first direction.

23. The image-forming device of claim 21, wherein the markings are szied to match a field of view of the optical media advancement sensor.
